(19) United States
(12) Patent Application Publication
(10) Pub. No.: US 2003/0174459 A1
(43) Pub. Date: Sep. 18, 2003

(54) Method for manufacturing tantalum sintered object for electrolytic capacitor

(76) Inventors: Yoshikazu Noguchi, Aizuwakamatsu-shi (JP); Tomoo Izumi, Sendai-shi (JP)

Correspondence Address: SUGHRUE MION, PLLC, 2100 PENNSYLVANIA AVENUE, N.W., WASHINGTON, DC, 20037, US

(21) Appl. No.: 10/343,949

(22) PCT Filed: Aug. 9, 2001
(86) PCT No.: PCT/JP01/06853

(30) Foreign Application Priority Data
Aug. 10, 2000 (JP) 2000-243366

(51) Int. Cl. H01G 9/042

(52) U.S. Cl. 361/509

(57) ABSTRACT

An object of the present invention is to provide a tantalum sintered body which has high performance such as a reduced leakage current and an improved resistance to lowering of the capacitance, depending on a size of a desired capacitor. In order to achieve the object, the present invention provide a production method of a tantalum sintered body for an electrolytic capacitor comprising the steps of: a molding step (I) in which a tantalum powder having a bulk density of 0.50 to 1.85 g/cm³, which is obtained by heat treating a deoxidized tantalum powder in an inert gas atmosphere at a high temperature and crushing, is molded so that the density is 4.5 to 7.0 g/cm³ and a volume is less than 5 mm³; and

a sintering step in which the molded product is heated in a vacuum so that a volume shrinkage percentage is 2 to 15%. In addition, instead of the molding step (I), a molding step (II) in which a tantalum powder having a bulk density of 1.75 to 2.5 g/cm³, which is obtained by heat treating a deoxidized tantalum powder in an inert gas atmosphere at a high temperature and crushing, is molded so that the density is 4.5 to 7.0 g/cm³ and a volume is 5 mm³ or greater, can be comprised.

### TECHNICAL FIELD

The present invention relates to a production method of a tantalum sintered body for an electrolytic capacitor.

### BACKGROUND ART

In the past, in order to produce an electrolytic capacitor using a tantalum powder, first, a tantalum compound was deoxidized, the obtained deoxidized tantalum powder was heat aggregated by heat treating in an inert gas atmosphere at a high temperature such as 1,250 to 1,500° C., and oxygen in the powder was removed by heat treating in the presence of an oxidizer at a low temperature such as 800 to 1,000° C.

After crushing the aggregates, a metal wire was embedded in the obtained powder, the powder is molded into a pellet, and a sintered body was obtained by sintering the pellet.

After the sintered body was chemically converted and oxidized, on the treated sintered body, a solid electrolyte layer made of manganese dioxide, lead oxide, conductive polymers and the like, a graphite layer, and a silver paste layer were formed in sequence by well-known methods, and after that, a cathode terminal was connected to the surface of the layered product by soldering and other methods, a resin cover was formed, and thereby an anode electrode for a solid electrolytic capacitor was produced.

Tantalum electrolytic capacitors having different sizes have been produced. Based on their size, tantalum electrolytic capacitors can be roughly classified into large tantalum electrolytic capacitors produced from pellet molded products having a volume of 5 mm³ or greater and small tantalum electrolytic capacitors produced from pellet molded products having a volume of less than 5 mm³.

In the large tantalum electrolytic capacitors, an impregnation of a solid electrolyte in the tantalum sintered body is easily insufficient, and a capacitance thereof sometimes decreases, and a leakage current sometimes increases.

In the small tantalum electrolytic capacitors, a strength of the molded product is easily insufficient, and a strength of the obtained sintered body is also insufficient, and a leakage current of the produced capacitors sometimes increases.

Thus, problems generated in the tantalum electrolytic capacitors differ depending on their size. Methods which can solve these problems have not been suggested.

### DISCLOSURE OF THE INVENTION

Therefore, one object of the present invention is to provide a tantalum sintered body which can produce a high performance tantalum electrolytic capacitor which has reduced leakage current and is free from reductions in capacitance, depending on the volume of the capacitor.

A production method of a tantalum sintered body for an electrolytic capacitor of the present invention comprises the steps of: a molding step (I) in which a tantalum powder having a bulk density of 0.50 to 1.85 g/cm³, which is obtained by heat treating a deoxidized tantalum powder in an inert gas atmosphere at a high temperature and crushing, is molded so that the density is 4.5 to 7.0 g/cm³ and a volume is less than 5 mm³; and a sintering step in which the molded product is heated in a vacuum so that a volume shrinkage percentage is 2 to 15% and a sintered body is obtained.

Another production method of a tantalum sintered body for an electrolytic capacitor of the present invention comprises the steps of: a molding step (II) in which a tantalum powder having a bulk density of 1.75 to 2.5 g/cm³, which is obtained by heat treating a deoxidized tantalum powder in an inert gas atmosphere at a high temperature and crushing, is molded so that the density is 4.5 to 7.0 g/cm³ and a volume is 5 mm³ or greater; and a sintering step in which the molded product is heated in a vacuum so that a volume shrinkage percentage is 2 to 15% and a sintered body is obtained.

In these production methods, it is preferable for the deoxidized tantalum powder to be a deoxidized tantalum which is obtained by deoxidizing tantalum potassium fluoride (K₂TaF₇) using sodium.

In these production methods, it is preferable to comprise a deoxidation step, before the molding step, in which a deoxidized tantalum powder or a tantalum powder is heat treated at a low temperature in the presence of magnesium and acid cleaned.

In these production methods, it is preferable for a specific surface area of the deoxidized tantalum powder measured by the BET method to is 0.8 to 4 m²/g.

In addition, in these production methods, it is also preferable for the sintered body which is chemically converted at 60° C. and 20V in 0.02% by weight of phosphoric acid solution to have a specific capacitance of 40,000 to 150,000 μFV/g, in accordance with EIAJ RC-2361.

### BEST MODE FOR CARRYING OUT THE INVENTION

A detailed description of a production method of a tantalum sintered body for an electrolytic capacitor according to the present invention will be given below.

In the production method, a tantalum powder, which is obtained by heat treating a deoxidized tantalum powder in an inert gas atmosphere at a high temperature and crushed, is used as a raw material.

The deoxidized tantalum powder is generally obtained by adding dividedly or continuously a tantalum compound and a deoxidizer in a diluent salt which is prepared by heating and melting a salt mixture such as KCl-KF, KCl-NaCl at 800 to 900° C., and reacting.

The tantalum compound includes potassium fluorides such as tantalum potassium fluorides; tantalum chlorides such as tantalum pentachlorides, lower tantalum chlorides; tantalum iodides; tantalum bromides; and the like. The oxidizer includes alkaline metals and alkaline earth metals such as sodium, magnesium, and calcium; hydrides thereof such as magnesium hydrides, and calcium hydrides; and the like.

An amount of the diluent salt is preferably 1.5 to 20 times the total amount of the tantalum compound and the oxidizer. If the amount of the diluent salt is less than 1.5 times the total, since the concentration of the tantalum compound as a raw material is high and the reaction rate is too fast, the particle diameter of the obtained tantalum particles may be too large. In contrast, if the amount of the diluent salt exceeds 20 times, there is a tendency for the reaction rate to be too slow and for the productivity to be decreased.

Moreover, it is possible to add a boron compound such as boron oxide (B₂O₃) and boron potassium fluoride (KBF₄) to the diluent salt during the deoxidization reaction. Excessive fineness of the deoxidized tantalum powder can be prevented by adding a boron compound. An amount of boron added to the diluent salt is preferably 2 to 100 ppm relative to the tantalum powder.

After completion of the reaction between the tantalum compound and the deoxidizer, the diluent salt is cooled, the obtained aggregates are washed repeatedly with water, a weak acidic solution, and the like, and thereby the diluent salt is removed, and deoxidized tantalum powder is obtained. After that, if necessary, a separation process such as centrifugation or filtration may be performed. In addition, it is also possible to wash and purify the obtained powder using a solution containing hydrogen fluoride and hydrogen peroxide. Thus obtained deoxidized tantalum powder has generally a specific surface area measured by the BET method of 0.8 to 4 m²/g.

Then, the deoxidized tantalum powder is heat treated in an inert gas atmosphere at a high temperature such as 1,000-1,500° C. for about 10 minutes to 2 hours, and thereby heat aggregated. The inert gas atmosphere includes an inert gas atmosphere such as helium, argon, and a reduced pressure atmosphere such as about less than 10⁻³kPa. Before the heat aggregation, a pre-aggregation, in which an amount of water such that the whole powder is uniformly weted, is added while the powder is vibrated using a centrifugal machine, may be performed. Due to the pre-aggregation, firmer aggregates can be obtained. If about 20 to 300 ppm of phosphorous, 2 to 100 ppm of boron, or the like relative to an amount of metal, that is, the deoxidized tantalum powder, is added to water used in the pre-aggregation, it is possible to prevent a fusion growth of the primary particles and to heat aggregate the primary particles while maintaining a large surface area.

The phosphorous used in the pre-aggregation includes phosphoric acid, phosphorous ammonium hexafluoride, and the like. The boron includes a boron compound such as boron oxide (B₂O₃), boron potassium fluoride (KBF₄), and the like. Moreover, phosphorous may be added at any time before the molding step which is explained below. By adding phosphorous before the molding step, an excess sintering in the latter sintering step can be prevented.

After the high temperature heat treatment, the heat aggregated deoxidized tantalum powder is crushed and thereby a bulk density thereof is adjusted.

The production method of the present invention comprises a molding step (I) in which a certain amount of a tantalum powder having a bulk density of 0.50 to 1.85 g/cm³ is weighed, and put into a mold and pressed, and thereby a pellet molded product (below, representing as a small molded product) which has a cylindrical or prism shape, a density of 4.5 to 7.0g/cm³, and a volume of less than 5 mm³, or a molding step (II) in which a certain amount of a tantalum powder having a bulk density of 1.75 to 2.5 g/cm³ is weighed, and put into a mold and pressed, and thereby a pellet molded product (below, representing as a large molded product) which has a cylindrical or prism shape, a density of 4.5 to 7.0g/cm³, and a volume of 5 mm³ or greater. In these molding steps (I) and (II), if necessary, a binder such as camphor (C₁₀H₁₆O) or a lubricant such as poly acrylic carbonates may be added. Moreover, a bulk density in the present invention is measured by a method in accordance with JIS Z 2504.

In the molding step (I) for preparing a small molded product, when a tantalum powder having a bulk density of 0.50 to 1.85 g/cm³, preferably 1.0 to 1.80 g/cm³ is used, it is possible to lower a leakage current generated in a tantalum electrolytic capacitor comprising an anode electrode made from a sintered body which is made by sintering this small molded product.

In the molding step (I), if a tantalum powder having a bulk density of more than 1.85 g/cm³ is used and a certain amount of the tantalum powder is put into a mold, since a volume of the tantalum powder is small, and a press stroke in pressing, that is, the so-called a pressing ratio, is small, it is difficult to apply sufficient pressure to the tantalum powder. As this result, a strength of the obtained small molded product is insufficient, and a sintered body which is obtained by sintering the obtained small molded product will also have an insufficient strength. Therefore, a leakage current of a tantalum electrolytic capacitor made from this tantalum sintered body will increase.

In addition, when a capacitor is produced, a metal wire is generally embedded in a tantalum powder and molding is carried out. If sufficient pressure is not applied in pressing, the metal wire will be easily removed from the obtained small molded product. The phenomenon in that a metal wire is easily removed, that is, a decrease of a strength required for picking a metal wire also increase a leakage current of a tantalum electrolytic capacitor which is finally obtained.

In contrast, if a bulk density of a tantalum powder is less than 0.50 g/cm³, a fluidity of the tantalum powder is inferior, and putting a certain amount of the tantalum powder in a mold becomes difficult.

Moreover, a volume of a small size molded product is generally is 0.01 mm³ or greater and less than 5 mm³.

A bulk density of a tantalum powder can be adjusted by adjusting crushing conditions after the high temperature heat treatment of the deoxidized tantalum powder. In addition, a bulk density of a tantalum powder can also be adjusted by adjusting a grain size of the deoxidized tantalum powder before the high temperature heat treatment or a temperature at the high temperature heat treatment.

Specifically, in order to adjust a bulk density of a tantalum powder to 0.50 to 1.82 g/cm^{3,} a grain size of the deoxidized tantalum powder before the high temperature heat treatment is maintained to large, and thereby the number of points of contact during the heat aggregation is maintained small as possible, and the powder surface is etched by acid washing; or a temperature at the high temperature heat treatment decreases to 1,200 to 1,250° C., for example, when the ordinary temperature at the high temperature heat treatment is 1,300° C., and thereby a shrinkage due to the heat aggregation is minimized.

When a tantalum powder having a bulk density of 0.50 to 1.85 g/cm³ is used in the molding step (I), a small molded product having a volume less than 5 mm³, a sufficient pellet strength of 3 kg or greater and a strength required for picking a metal wire of 0.8 kg or greater, can be prepared. As this result, a strength of a sintered body made from this small molded product is also excellent, and a tantalum electrolytic capacitor comprising an improved leakage current can be produced.

Moreover, the pellet strength is a load at which cracking begins to occur in a cylindrical pellet having a diameter of 1 mm, made from 6 mg of a tantalum powder, with the load applied to the cylindrical pellet in a radial direction.

The strength required for picking a metal wire is a force which is required to pick a metal wire having a diameter of 0.09 mm from the cylindrical pellet which is obtained by embedding the metal wire in a tantalum powder and molding the cylindrical pellet.

In the molding step (I), a density of the small molded product is 4.5 to 7.0 g/cm³. If a density of the small molded product is less than 4.5 g/cm³, a capacitance relative to a volume decreases, and it is difficult to achieve a high volumetric efficiency which is required to a tantalum electrolytic capacitor. In contrast, if it exceeds 7.0 g/cm³, the vacancies between particles comprising a tantalum powder decreases, and it is difficult to be impregnated a solid electrolyte such as manganese dioxide (MnO₂). The volumetric efficiency shows a relationship between a volume and a capacitance of a capacitor, specifically, a capacitance per a unit volume.

In the molding step (II) for preparing a large molded product, when a tantalum powder having a bulk density of 1.75 to 2.5 g/cm³, preferably 1.80 to 2.2 g/cm³ is used, it is possible to lower a leakage current generated in a tantalum electrolytic capacitor comprising an anode electrode made from a sintered body which is made by sintering this large molded product. In addition, a capacitor having high performance such as sufficient capacitance can be produced.

In the molding step (II), if a tantalum powder having a bulk density less than 1.75 g/cm³ is used, when a certain amount of the tantalum powder is put into a mold, a volume of the tantalum powder is large, and an excessive press is applied to the tantalum powder. As this result, the tantalum powder is pressed to the walls of the mold with excessive pressure, pores at the surface of the large molded product may be closed, and a pore size in the inside of the molded product may decrease. If such large molded product is sintered, the pores in the obtained sintered body also becomes small, and it is difficult to be impregnated a sufficient amount of a solid electrolyte. Therefore, a tantalum electrolytic capacitor made from this tantalum sintered body will have a large amount of leakage current and a lower capacitance.

In contrast, if a bulk density of a tantalum powder exceeds 2.5 g/cm³, since pores in each aggregate in which a tantalum powder is aggregated becomes small and vacancies between aggregates become extremely large, it is impossible to form uniformly a film of manganese dioxide (MnO₂). Moreover, a volume of the large molded product is generally 5 to 180 mm^{3.}

As explained above, a bulk density of a tantalum powder can be adjusted by adjusting crushing conditions after the high temperature heat treatment of the deoxidized tantalum powder as well, adjusting a grain size of the deoxidized tantalum powder before the high temperature heat treatment or a temperature at the high temperature heat treatment. Specifically, in order to adjust a bulk density of a tantalum powder to 1.75 to 2.5 g/cm³, the deoxidized tantalum powder before the high temperature heat treatment is crushed and the grain size thereof is small, and thereby the deoxidized tantalum powder comprising large pores when it is in a sparse aggregation conditions is compacted. In addition, it is possible to adjust a bulk density by a method in which the deoxidized tantalum powder is immersed in water, and dried and thereby an adhesion increases. Due to this, a shrinkage at the high temperature heat treatment increases. Furthermore, a method in which a temperature in the high temperature heat treatment raises to 1,350- 1,400° C., for example, when the ordinary temperature at the high temperature heat treatment is 1,300° C., and thereby the tantalum powder is densified can achieve such bulk density.

When a tantalum powder having a bulk density of 1.75 to 2.5 g/cm³ is used in the molding step (II), a large molded product having a volume of 5 mm³ or greater and comprising pores having a suitable size, can be prepared. As this result, a sintered body having an impregnation rate of a solid electrolyte of 80% or greater can be produced. In addition, a tantalum electrolytic capacitor having a capacitance achievement percentage of 85% or greater, preferably 90% or greater can be produced by using this sintered body.

The impregnation rate of a solid electrolyte is a percentage of a surface area that is covered with a solid electrolyte such as MnO₂ relative to a total surface area of a chemical conversion film in the sintered body. The impregnation rate can be judged by the capacitance achievement percentage.

The capacitance achievement percentage is a percentage of an electrical capacitance of a capacitor obtained by impregnating a solid electrolyte in a sintered body relative to an electrical capacitance of a sintered body in an electrolyte such as phosphoric acid or sulfuric acid after the chemical conversion and oxidation and before an impregnation of a solid electrolyte.

Moreover, in the molding step (II), a density of the large molded product is 4.5 to 7.0 g/cm³. If a density of the large molded product is less than 4.5 g/cm³, a capacitance per a unit volume decreases, and it is difficult to achieve a high volumetric efficiency which is required to a tantalum electrolytic capacitor. In contrast, it exceeds 7.0 g/cm³, the vacancies between particles comprising a tantalum powder decreases, it is difficult to be impregnated a solid electrolyte such as manganese dioxide (MnO₂).

Before the molding steps (I) and (II), a deoxidation step may be performed in which a tantalum powder having a bulk density of 0.50 to 1.85 g/cm³ or a tantalum powder having a bulk density of 1.75-2.5 g/cm³ is heat treated at a low temperature in the presence of magnesium and acid washed. In the deoxidation step, a tantalum powder in which magnesium is added is heat treated at 700 to 1,000° C., usually for 2-10 hours. After a slow oxidation treatment in which air is gradually introduced in the deoxidized tantalum powder and thereby a stable film is formed on the surface of the tantalum powder, the tantalum powder is acid washed using an acid solution. By the acid washing, residual magnesium or magnesium oxide generated from magnesium can be removed.

After the molding step (I) or (II), a sintering step, in which the obtained small or large molded product is heated in a vacuum so that a volume shrinkage is 2 to 15% and a sintered body is obtained, is performed. Moreover, a vacuum in the sintering step means 10⁻⁴ kPa or less. In addition, a heating temperature is about 1,100 to 1,600° C., preferably 1,200 to 1,500° C., and a heating period is 10 minutes to 1 hour. Furthermore, the volume shrinkage is a percentage of a difference between a volume of a molded product and a volume of a sintered body relative to a volume of the molded product.

In the sintering step, if a volume shrinkage is less than 2%, a strength of a sintered body is insufficient, and such sintered body is not suitable for practical use. In contrast, if it exceeds 15%, a volume shrinkage due to a sintering is too large, it is difficult to control a size of a sintered body. By adjusting a volume shrinkage to 2 to 15%, a sintered body suitable for a tantalum electrolytic capacitor can be produced.

When the obtained sintered body is converted at 60° C. and 20V, in 0.02% by weight of phosphoric acid solution, in accordance with EIAJ RC-2361, a sintered body having a specific capacitance of 40,000 to 150,000 μmFV/g can be obtained.

The EIAJ RC-2361 is one of the Standards of the Electronic Industries Association of Japan and details a test method for a tantalum sintered element for an electrolytic capacitor. In the present invention, the sintered body is chemically converted and a specific capacitance thereof is measured, in accordance with EIAJ RC-2361. The detailed measuring method will be explained below.

First, a lead wire is embedded in the deoxidized tantalum powder, press molding is carried out, and the molded product is sintered under the above-mentioned conditions and thereby a sintered body, in which the lead wire is integrated with the deoxidized tantalum powder, is produced. Then, the obtained sintered body is put in an electrolyte containing about 0.02 to 0.5% by weight of phosphoric acid, nitrous acid, or the like, at a certain temperature, for example, 30-90° C., the voltage gradually increases to a range from 10 to 60 V while the current density is set to a range from 30 to 120 mA/g, and the voltage is maintained for 1-3 hours, and thereby an anode element is chemically converted. After that, the converted anode element is washed with purified water at 85° C., dried, and a specific capacitance thereof is measured. The specific capacitance is measured in a sulfuric acid solution of about 30% by weight at 25° C. under conditions such that a bias voltage is 1.5V, and a measuring frequency is 120 Hz.

Onto the chemical converted sintered body, an solid electrolyte layer made of manganese dioxide, lead oxide, conductive polymers, and the like, a graphite layer, and a silver paste layer are formed in sequence by well-known methods, and thereby an anode element is prepared. After that, a negative terminal is connected to the surface of the anode element by soldering and other methods, a resin cover is formed, and thereby a solid electrolytic capacitor is produced.

Since a deoxidized tantalum powder used in the present invention is obtained by heat treating the deoxidized tantalum powder at a high temperature for example 1,000° C. or greater and less than 1,250° C., and heat treating at a low temperature of 700 to 1,000° C., the deoxidized tantalum powder has a large surface area of about 2-5m²/g, and is fine and not excessively aggregated. This tantalum powder is suitable for an anode electrode comprising a tantalum electrolytic capacitor.

A production method of a tantalum sintered body for an electrolytic capacitor of the present invention comprises a molding step (I) in which a deoxidized tantalum powder is heat treated in an inert gas atmosphere at a high temperature, and crushed, and thereby a tantalum powder having a bulk density of 0.50 to 1.85 /cm³ is obtained, and then the small molded product is obtained by molding the obtained tantalum powder so that the density is 4.5 to 7.0 g/cm³ and a volume is less than 5 mm³. Therefore, since the tantalum powder can be pressed with a suitable pressure, a small molded product, which has an excellent strength and from which a metal wire is hardly removed, can be produced. In addition, in a following sintering step, the obtained small molded product is heated in a vacuum such that a volume shrinkage is 2-15%, and thereby a sintered body is produced. Therefore, according to the production method of the present invention, a sintered body having an excellent strength can be produced.

In addition, a small tantalum electrolytic capacitor having an improved leakage current can be produced by using the sintered body.

In addition, another production method of a tantalum sintered body for an electrolytic capacitor of the present invention comprises a molding step (II) in which a deoxidized tantalum powder is heat treated in an inert gas atmosphere at a high temperature, and crushed, and thereby a tantalum powder having a bulk density of 1.75 to 2.5 /cm³ is obtained, and then the large molded product is obtained by molding the obtained tantalum powder so that the density is 4.5 to 7.0 g/cm³ and a volume is 5 mm³ or greater. Since the tantalum powder is pressed with an appropriate pressure, without being pressed to the walls of the mold with excessive pressure, it is possible to prevent a close of pores formed in the surface of a pellet and excessive fineness of the pores in the inside of the pellet. In addition, in a following sintering step, the obtained large molded product is heated in a vacuum so that a volume shrinkage percentage is 2 to 15%, and thereby a sintered body is produced. Therefore, a sintered body, which has pores having an appropriate size and in which a solid electrolyte easily impregnates, can be produced.

Consequently, a large tantalum electrolytic capacitor, which has a reduced leakage current and has improved resistance to lowering of the capacitance, can be produced using the sintered body.

Thus, according to the present invention, since a bulk density of a tantalum powder is adjusted depending on a size of the desired tantalum electrolytic capacitor, a sintered body, which has a specific capacitance of 40,000 to 150,000 μmFV/g when it is chemically converted in 0.02% by weight of phosphoric acid solution at 60° C. and 20V, in accordance with EIAJ RC.-2361, can be stably produced.

### EXAMPLE

Below, the present invention will be further explained referring to examples.

### Examples 1-14

A deoxidized tantalum powder, which was obtained by deoxidizing tantalum potassium fluoride using sodium in a diluent salt containing potassium fluoride and potassium chloride, was put into a heat furnace and subjected to the high temperature heat treatment in a reduced pressure, 10⁻⁵-10⁻³ kPa at 1,150-1,350° C., and thereby the deoxidized tantalum powder was heat aggregated. After crushing the heat aggregated tantalum powder, the tantalum powders having different bulk densities of 1.20-1.85 g/cm³ in Table 1 were obtained and pressed by a compression molding machine, and fourteen small pellets having a volume of 2 mm³ were prepared.

A pellet strength and a strength required for picking a metal wire of the prepared fourteen small pellets were measured with the following methods. The results are shown in Table 1.

After that, these pellets were heated and sintered in a vacuum at 1,250 to 1,400° C. for 20 to 30 minutes such that a volume shrinkage was 2 to 15%.

The obtained sintered bodies were chemically converted in a phosphoric acid solution of 0.02% by weight at 60° C. and 20V, and then CV value was measured in a phosphoric acid solution of 30.5% by weight at 25° C., in accordance with EIAJ RC.-2361. The CV values are also shown in Table 1.

(1) Pellet strength

A pellet was made from 6 mg of the tantalum powder, the obtained pellet was arranged on a stage of a compression test machine so that the radial direction of the pellet corresponds to a vertical direction, and a load was applied to the pellet in the radial direction. A load in that a crack began to generate in the pellet is defined as a pellet strength.

(2) Strength required for picking a metal wire

A metal wire having a diameter of 0.09 mm was embedded in a pellet which was made from 6 mg of the tantalum powder, similarly in the pellet strength test, and a force required for picking the metal wire from the pellet was measured. The force was defined as a strength required for picking a metal wire.

### Comparative Examples 1-5

Five Comparative small pellets having a volume of 5 mm³ were produced in a manner identical to that of Example 1, except that tantalum powders having bulk densities of 1.90 to 2.10 g/cm³ were used.

A pellet strength and a strength required for picking a metal wire of these comparative small pellets were measured, similarly in the Example 1. The results are also shown in Table 1.

After that, sintered bodies were produced using these comparative small pellets and CV values were measured in a manner identical to that of Example 1. The results are also shown in Table 1.

TABLE 1

| | | | Strength required | |
|---|---|---|---|---|
| | Bulk | Pellet | for picking | CV |
| | Density | Strength | a metal wire | value |
| | (g/cm³) | (kg) | (kg) | (μFV/g) |
| Example 1 | 1.20 | >10 | >3 | 47,000 |
| Example 2 | 1.25 | >10 | >3 | 42,000 |
| Example 3 | 1.30 | >10 | >3 | 57,000 |
| Example 4 | 1.35 | >10 | >3 | 52,000 |
| Example 5 | 1.40 | >10 | 3 | 52,000 |
| Example 6 | 1.45 | >10 | 2.9 | 52,000 |
| Example 7 | 1.50 | 10 | 2.7 | 57,000 |
| Example 8 | 1.55 | 9 | 2.5 | 47,000 |
| Example 9 | 1.60 | 8 | 2.2 | 52,000 |
| Example 10 | 1.65 | 7 | 2 | 52,000 |
| Example 11 | 1.70 | 6 | 1.6 | 52,000 |
| Example 12 | 1.75 | 5 | 1.3 | 47,000 |
| Example 13 | 1.80 | 4 | 1 | 47,000 |
| Example 14 | 1.85 | 3 | 0.8 | 42,000 |
| Comparative Example 1 | 1.90 | 2 | 0.6 | 53,000 |
| Comparative Example 2 | 1.95 | 1.5 | 0.4 | 42,000 |
| Comparative Example 3 | 2.00 | 1 | 0.3 | 52,000 |
| Comparative Example 4 | 2.05 | 0.7 | 0.2 | 57,000 |
| Comparative Example 5 | 2.10 | 0.5 | 0.2 | 47,000 |

In general, a pellet having a pellet strength of 3 kg or greater, preferably 4 kg or greater, and a strength required for picking a metal wire of 0.8 kg, preferably 1 kg or greater is considered a pellet suitable for a practical capacitor.

It is clear from Table 1 that pellets made from tantalum powders having a bulk density of 1.20 to 1.85 g/cm³ have a pellet strength of 3 kg or greater and a strength required for picking a metal wire of 0.8 kg or greater.

### Examples 15 to 22

A deoxidized tantalum powder, which was obtained by deoxidizing tantalum potassium fluoride using sodium in a diluent salt containing potassium fluoride and potassium chloride, was put into a heat furnace and subjected to the high temperature heat treatment at a reduced pressure, 10⁻⁵-10⁻³ kPa at 1,250-1,450° C. and thereby the deoxidized tantalum powder was heat aggregated.

After crushing the heat aggregated tantalum powder, the tantalum powders having different bulk densities of 1.75-2.10 g/cm³ in Table 2 were obtained and pressed by a compression molding machine, and eight large pellets having a volume of 21 mm³ were prepared.

After that, eight large pellets were heated and sintered in a vacuum at 1,350 to 1,450° C. for 20-30 minutes so that a volume shrinkage was 2 to 15%.

The obtained sintered bodies were chemically converted in a phosphoric acid solution of 0.02% by weight at 60° C., 20V, and then CV value (1) was measured in a phosphoric acid solution of 30.5% by weight at 25° C., in accordance with EIAJ RC-2361. The CV values (1) are also shown in Table 2.

Furthermore, sintered bodies, which were obtained in the same manner as described above, were chemically converted and oxidized, and an solid electrolyte was impregnated, a silver paste was coated, and then cathode electrodes were provided, and thereby tantalum electrolytic capacitors were produced. The CV value (2) of the obtained capacitors was measured.

After that, a capacitance achievement percentage was calculated based on the CV value (1) measured in a sulfuric acid of 30.5% by weight at 25° C. and the CV value (2). The calculated capacitance achievement percentages are shown in Table 2.

### Comparative Examples 6-16

Eleven Comparative large pellets having a volume of 5 mm³ were produced in a manner identical to that of Example 15, except that tantalum powders having bulk densities of 1.20-1.70 g/cm³ were used.

The CV value (1) and CV value (2) were measured, similarly in the Example 15. In addition, a capacitance achievement percentage was also calculated. These results are also shown in Table 2.

TABLE 2

| | | Capacitance | |
|---|---|---|---|
| | | Achievement | |
| | Density | Percentage | CV Value (1) |
| | (g/cm³) | (%) | (μFV/g) |
| Example 15 | 1.75 | 85 | 47,000 |
| Example 16 | 1.80 | 90 | 47,000 |
| Example 17 | 1.85 | 93 | 42,000 |
| Example 18 | 1.90 | 92 | 53,000 |
| Example 19 | 1.95 | 95 | 42,000 |
| Example 20 | 2.00 | 94 | 52,000 |
| Example 21 | 2.05 | 91 | 57,000 |
| Example 22 | 2.10 | 96 | 47,000 |
| Comparative Example 6 | 1.20 | 60 | 47,000 |
| Comparative Example 7 | 1.25 | 65 | 42,000 |
| Comparative Example 8 | 1.30 | 63 | 57,000 |
| Comparative Example 9 | 1.35 | 68 | 52,000 |
| Comparative Example 10 | 1.40 | 69 | 52,000 |
| Comparative Example 11 | 1.45 | 70 | 52,000 |
| Comparative Example 12 | 1.50 | 70 | 57,000 |
| Comparative Example 13 | 1.55 | 75 | 47,000 |
| Comparative Example 14 | 1.60 | 75 | 52,000 |
| Comparative Example 15 | 1.65 | 78 | 52,000 |
| Comparative Example 16 | 1.70 | 80 | 52,000 |

It is clear from Table 2 that since tantalum electrolytic capacitors made from tantalum powders having bulk densities of 1.75 to 2.1 g/cm³ comprise pores suitable for being impregnated a solid electrolyte, the tantalum electrolytic capacitors can be impregnated a sufficient amount of a solid electrolyte and have excellent capacitance achievement percentages.

### Industrial Applicability

As has been described above, according to the production method for a tantalum sintered body used for a solid electrolytic capacitor of the present invention, since a bulk density of a tantalum powder can be adjusted depending on a size of a desired capacitor, a pressure applied to a tantalum powder in a molding step can be adjusted in the case whether a small molded product or a large molded product is produced.

Therefore, a molded product having an excellent strength and an adjusted pore size can be produced. A tantalum sintered body, which is obtained by sintering the molded product, is suitable for an anode electrode comprising an electrolytic capacitor.

Consequently, when a tantalum sintered body for an electrolytic capacitor which is produced by the production method of the present invention is used, a tantalum electrolytic capacitor which has high performance such as a reduced leakage current and an improved resistance to lowering of the capacitance, in the case whether the capacitor is a small size or a large size.

1. A production method of a tantalum sintered body for an electrolytic capacitor comprising the steps of:
a molding step (I) in which a tantalum powder having a bulk density of 0.50 to 1.85 g/cm³, which is obtained by heat treating a deoxidized tantalum powder in an inert gas atmosphere at a high temperature and crushing, is molded so that the density is 4.5 to 7.0 g/cm³ and a volume is less than 5 mm³; and
a sintering step in which the molded product is heated in a vacuum so that a volume shrinkage percentage is 2 to 15% and a sintered body is obtained.

2. A production method of a tantalum sintered body for an electrolytic capacitor comprising the steps of:
a molding step (II) in which a tantalum powder having a bulk density of 1.75 to 2.5 g/cm³, which is obtained by heat treating a deoxidized tantalum powder in an inert gas atmosphere at a high temperature and crushing, is molded so that the density is 4.5 to 7.0 g/cm³ and a volume is 5 mm³ or greater; and
a sintering step in which the molded product is heated in a vacuum so that a volume shrinkage percentage is 2 to 15% and a sintered body is obtained.

3. A production method of a tantalum sintered body for an electrolytic capacitor according to claim 1 or 2, wherein the deoxidized tantalum powder is obtained by deoxidizing tantalum potassium fluorides using sodium.

4. A production method of a tantalum sintered body for an electrolytic capacitor according to any one of claims 1 to 3, wherein the production method further comprises a deoxidation step, before the molding step, in which a deoxidized tantalum powder or a tantalum powder is heat treated at a low temperature in the presence of magnesium and washed with acids.

5. A production method of a tantalum sintered body for an electrolytic capacitor according to any one of claims 1 to 4, wherein a specific surface area of the deoxidized tantalum powder measured by the BET method is 0.8 to 4 m²/g.

6. A production method of a tantalum sintered body for an electrolytic capacitor according to any one of claims 1 to 5, wherein the sintered body which is chemically converted at 60° C. and 20V has a specific capacitance of 40,000 to 150,000 μmFV/g.
